(19) United States
(12) Patent Application Publication
(10) Pub. No.: US 2005/0156965 A1
(43) Pub. Date: Jul. 21, 2005

(54) Inkjet recording apparatus

(75) Inventor: Yoshihide Hoshino, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Medical & Graphic, Inc., Tokyo (JP)

(21) Appl. No.: 11/032,251

(22) Filed: Jan. 10, 2005

(30) Foreign Application Priority Data
Jan. 19, 2004 (JP) JP2004-010816
Mar. 17, 2004 (JP) JP2004-076727

(51) Int. Cl. B41J 29/38

(52) U.S. Cl. 347/9

(57) ABSTRACT

An inkjet recording apparatus provided with: a plurality of recording heads, each of the plurality of recording heads being provided with an outlet for ejecting, photocurable ink of different color from each other; a light exposure device for curing the photocurable ink ejected; a controller for controlling ejection of the photocurable ink in such a way that a center position of an ink dot recorded by one of the plurality recording heads is positioned at a position shifted from a center position of an ink dot recorded by other multiple heads of the plurality of recording heads.

### BACKGROUND OF THE INVENTION

The present invention relates to an inkjet recording apparatus, particularly to an inkjet recording apparatus wherein recording is carried out by shifting the center position of the ink dot recorded by some of recording heads, from that of the ink dot recorded by other recording heads.

In the field of printing, gravure printing or flexographic printing is commonly employed. The gravure or flexographic printing requires prepress operation, and is accompanied by costwise disadvantages when printing in a small lot. Thus, attention is focused on the inkjet recording method, different from the prior art gravure or flexographic printing technique, capable of reducing the costwise disadvantages in small-lot printing, without the need of prepressing operation, and compatible with printing on a wide variety of recording mediums.

Particularly, a photocurable inkjet recording apparatus using such photocurable ink as radical polymerized ink or cation polymerized ink is now capable of providing a high quality recording image comparable to a silver halide photograph (Patent Document 1).

[Patent Document 1] Official Gazette of Japanese Patent Tokkai-2001-310454

In the inkjet recording apparatus, when water based ink or oil based ink is used, much of the ink is absorbed by the recording medium. When photocurable ink is used, the photocurable ink remains on the recording medium without being absorbed. FIG. 11 is a schematic cross sectional view showing the case where all ink dot center positions are superimposed one on top of another to perform recording. The yellow ink dot 1b is superimposed on the dot la of the photocurable ink of magenta, cyan and black, and is recorded on the recording medium 8 and recording is performed. When this is put to microeconomic observation, ink is hardened with the ink-hit portion excessively bulged. This causes the variations, irregularities (convexoconcave) and excessive glossiness in the image. This phenomenon is conspicuous in the recording area where much ink is used. When many types of ink are used as in the case where light magenta and light cyan are also used in addition to yellow, magenta, cyan and black as basic colors, the gritty feel, irregularities and uneven glossiness on the image will appear conspicuous.

The object of the present invention is to provide an inkjet recording apparatus capable of reducing the difference in gritty feel and irregularities and minimizing the deterioration of image quality.

Incidentally, the Patent Document 2 proposes a photocurable inkjet recording apparatus that ensures the uniform glossiness of an image by using a uniform amount of ink per unit area, and that employs the ink without coloring agent (hereinafter referred to as “clear ink”, in addition to the ink with coloring agent (hereinafter referred to as “color ink”), thereby improving the image storage stability.

[Patent Document 2] Official Gazette of Japanese Patent Tokkai 2003-191601

When the clear ink is used in a photocurable inkjet recording apparatus, uniform glossiness can be obtained to a certain extent. However, as shown in FIG. 17, when the clear ink hits the position where the color ink has hit before curing of the color ink, the color ink is mixed with the clear ink prior to, and is diffused. When the clear ink hits the position where the color ink has hit after the ink has cured, the irregularities on the surface of a recording medium caused by the clear ink are superimposed on those caused by the cured color ink, with the result that image quality is deteriorated. This is the problem with the aforementioned prior art.

In view of the prior art described above, it is an object of the present invention to provide an inkjet printer recording apparatus capable of: ensuring that the color ink having hit a recording medium is not mixed with the clear ink before being cured, even when clear ink is used; reducing the difference in the irregularities on the surfaces of the recording media; and minimizing the bleeding of ink, increase of dot diameter and irregularities on the surfaces, thereby preventing image quality from deteriorating.

### SUMMARY OF THE INVENTION

The-aforementioned object can be achieved by an inkjet recording apparatus having the following structure:

(1) An inkjet recording apparatus including: a plurality of recording heads, each of the plurality of recording heads being provided with an outlet for ejecting photocurable ink of different color from each other; a light exposure device for curing the photocurable ink ejected; a controller for controlling ejection of the photocurable ink in such a way that a center position of an ink dot recorded by one of the plurality recording heads is positioned at a position shifted from a center position of an ink dot recorded by other multiple heads of the plurality of recording heads.

According to the aforementioned structure (1), the center position of the dot of the ink recorded by one of the plurality recording heads can be recorded in the position shifted from that of the dot of the ink recorded by other multiple heads of the plurality of recording heads.

### BRIEF DESCRIPTION OF THE DRAWINGS

FIG. 1 is a schematic front view of the major configuration of the recording section of an inkjet recording apparatus based on serial head structure as a first embodiment, as viewed from the secondary scanning direction;

FIG. 2 is a schematic view showing the layout of the ink outlet of each recording head used in the first embodiment;

FIG. 3 is a functional block diagram of the inkjet recording apparatus in the first embodiment;

FIGS. 4(a) and 4(b) are schematic top views as an enlarged view showing part of the recording medium which the ink of cyan, magenta and black and the yellow ink have hit, according to the present invention;

FIGS. 5(a) and 5(b) are schematic cross sectional views representing the ink having hit the recording medium in the first embodiment;

FIG. 6 is a schematic cross sectional view representing the ink having hit the recording medium in the first embodiment;

FIG. 7 is a schematic cross sectional view representing the ink having hit the recording medium in the first embodiment;

FIG. 8 is a schematic front view representing the major configuration of the recording section of an inkjet recording apparatus based on serial head structure, as viewed from the secondary scanning direction of the recording medium in the second embodiment;

FIG. 9 is a schematic front view representing the major configuration of the recording section of an inkjet recording apparatus based on serial head structure, as viewed from the secondary scanning direction in the second embodiment;

FIG. 10 is a functional block diagram of the inkjet recording apparatus in the second embodiment;

FIG. 11 is a schematic cross sectional view representing the ink having hit the recording medium in the prior art;

FIG. 12 is a schematic front view representing the major configuration of an inkjet recording apparatus according to the present invention;

FIG. 13 is a schematic diagram representing the nozzle for ejecting clear ink and color ink of an inkjet printer recording apparatus according to the present invention;

FIG. 14 is a functional block diagram representing an inkjet printer recording apparatus according to the present invention;

FIGS. 15(a) and 15(b) are the side views showing the clear ink and color ink having hit, according to the present invention;

FIGS. 16(a) and 16(b) are the top views showing the clear ink and color ink having hit, according to the present invention; and

FIG. 17 is the top views showing the clear ink and color ink having hit, according to the prior art.

### DETAILED DESCRIPTION OF THE PREFERRED EMBODIMENT

The aforementioned object can also be achieved by an inkjet recording apparatus having the following structures:

(2) The inkjet recording apparatus described in the structure (1), wherein the controller controls ejection from said one of the plurality of recording heads in such a way that the center position of the ink dot recorded by said one of the plurality of recording heads is positioned intermediately between a center position of a first ink dot and a center position of a second ink dot adjacent to the first ink dot, the first ink dot and the second ink dot being recorded by said other multiple heads of the plurality of recording heads.

According to the aforementioned structure (2), the center position of the ink dot recorded by the aforementioned one of the recording heads out of the aforementioned recording heads can be recorded at the position further shifted from the center position of the ink dot recorded by other multiple heads of the plurality of recording heads.

(3) The inkjet recording apparatus described in the structure (1), wherein the controller controls ejection from said one of the plurality of recording heads in such a way that the center position of the ink dot recorded by said one of the plurality of recording heads is positioned intermediately between a center position of the first ink dot and a center position of a second ink dot adjacent to the first ink dot in an oblique direction, the first ink dot and the second ink dot being recorded by said other multiple heads of the plurality of recording heads.

According to the aforementioned structure (3), the center position of the ink dot recorded by the aforementioned one of the recording heads can be recorded at the position farthest from the center position of the ink dot recorded by other recording heads. The aforementioned “oblique direction” indicates the direction intermediate between the primary scanning direction and secondary scanning direction.

(4) The inkjet recording apparatus of any one of structures (1) through (3), wherein a center position of the ink outlet of said one of the plurality recording heads is provided between a center position of a first ink outlet and a center position of a second ink outlet adjacent to the first ink outlet, both of the first ink outlet and the second ink outlet being provided on said other multiple heads of the plurality of recording heads.

According to the aforementioned structure (4), in the inkjet recording apparatus described in any one of structures (1) through (3), the center position of the ink dot recorded by the aforementioned one of the recording heads can be easily recorded at the position shifted from the center position of the ink dot recorded by other multiple heads of the plurality of recording heads.

(5) The inkjet recording apparatus of any one of structures 1 through 4, wherein, said one of the plurality of recording heads is a recording head for ejecting photocurable ink of yellow color.

According to the aforementioned structure (5), the center position of the ink dot of yellow having the maximum lightness of all fundamental colors can be recorded at the position shifted from that of the other multiple heads of the plurality of recording heads.

(6) The inkjet recording apparatus of any one of structures (1) through (4), wherein the plurality of recording heads comprises multiple recording heads for ejecting ink of a same kind of hue, wherein the recording head for ejecting ink of the lowest recording density among the multiple recording heads is said one of the plurality of recording heads.

According to the aforementioned structure (6), when recording is carried out using multiple types of ink having the same hue, the center position of the dot of the ink having the lowest recording density can be recorded at the position shifted from the center position of the other ink dots.

(7) The inkjet recording apparatus of any one of structures (1) through (4), wherein, said one of the plurality of recording heads is a recording head for ejecting photocurable ink of fundamental color having the maximum glossiness after recording.

According to the aforementioned structure (7), the center position of the dot of the ink having the maximum glossiness can be recorded at a position shifted from that of the other ink dots.

(8) The inkjet recording apparatus of any one of structures (1) through (7), wherein the plurality of recording heads comprises the recording heads for respectively ejecting yellow ink, magenta ink, cyan ink and black ink.

According to the aforementioned structure (8), the center position of the ink dot recorded by one of the recording heads can be recorded at the position shifted from the center position of the ink dot recorded by other recording heads.

(9) An inkjet recording apparatus including: a plurality of recording heads, each of the plurality of recording heads being provided with an outlet for ejecting photocurable ink, the plurality of recording heads comprising a recording head for ejecting color ink and a recording head for ejecting clear ink; a light exposure device for curing the photocurable ink ejected; a transporting section for transporting a recording medium; and a controller for controlling ejection of the recording head for ejecting clear ink, in such a way that a center position of a clear ink dot recorded by the recording head for ejecting clear ink is positioned at a position shifted from a center position of an color ink dot recorded by the recording head for ejecting color ink.

According to the aforementioned structure (9), the center position of the dot of the aforementioned clear ink is recorded at the position shifted from that of the dot of the color ink, by the aforementioned controller of the inkjet recording apparatus, whereby mixing between color ink and, clear ink is avoided. Thus, the glossiness and hue different from those of the conventional arrangement can be obtained by shifting in a desired manner the center position of the dot of the color ink to be recorded, from that of the dot of the clear ink to be recorded.

(10) The inkjet recording apparatus of described in structure (9), wherein the controller controls in such a way that the center position of the clear ink dot is positioned substantially at a middle point between a center position of a first color ink dot and a center position of a second color ink dot adjacent to the first color ink dot.

According to the aforementioned structure (10), the center position of the dot of the aforementioned clear ink is recorded at the position equivalent to half the distance from the center position of the dot of the aforementioned color ink to that of the dot of the adjacent color ink, by means of the controller of the inkjet recording apparatus. This arrangement ensures effective prevention of the mixing between color ink and clear ink, and reduces the difference in the irregularities on the surfaces of the recording media.

(11) The inkjet recording apparatus of structure (9) or (10), wherein the controller controls in such a way that the center position of the clear ink dot is shifted from the center position of a color ink dot in a direction (hereinafter referred to as “oblique direction”) between a transporting direction of the recording media and a direction perpendicular to the transporting direction.

According to the aforementioned structure (11), the center position of the dot of the aforementioned clear ink is controlled in the oblique direction with respect to that of the dot of the color ink, by the controller of the inkjet recording apparatus, described in (9) and (10). This arrangement avoids the mixing between color ink and clear ink, and reduces the difference in the irregularities on the surfaces of the recording media, thereby minimizing an overflow of color ink even when the water based ink is used as color ink.

(12) The inkjet recording apparatus described in any one of (9) through (11), wherein the recording head is equipped with a plurality of ink outlets, and, the aforementioned clear ink recording head where the center position of the ink outlet of the clear ink recording head is located is provided in the position from the center position of the ink outlet of the color ink recording head to that of the ink outlet of the adjacent color ink recording head.

According to the aforementioned structure (12), in the inkjet recording apparatus described in any one of (9) through (11), the aforementioned clear ink recording head where the center position of the ink outlet of the clear ink recording head is located is provided in the position from the center position of the ink outlet of the color ink recording head to that of the ink outlet of the adjacent color ink recording head. This arrangement ensures most effective prevention of the mixing between color ink and clear ink, and reduces the difference in the irregularities on the surfaces of the recording media.

(13) The inkjet recording apparatus described in any one of structures (9) through (12), wherein the color ink contains the coloring agents of at least cyan, magenta, yellow and black.

According to the aforementioned structure (13), the arrangement adopted in the inkjet recording apparatus described in any one of (9) through (12) avoids mixing between the color ink containing the coloring agents of at least cyan, magenta, yellow and black, and the clear ink, and reduces the difference in the irregularities on the surfaces of the recording media.

Effects of the Invention

The inkjet recording apparatus described in (1) reduces the differences in the irregularities on the surface of the recording medium after curing of the ink. This arrangement ensures a uniform degree of glossiness and improves the image quality. It also enables to freely displace the superimposed dots where ink is recorded, thereby to get a degree of glossiness and hue different from those by the conventional method. Thus, this feature provides the advantage of allowing the glossiness and hue to be selected in conformity to the taste of the user.

The inkjet recording apparatus described in (2) reduces the difference in irregularities on the surfaces of the recording media after curing of the ink, and ensures uniform glossiness and improved image quality.

According to the aforementioned (3), recording is performed when the dot of the ink recorded by the aforementioned one of the recording heads is separated farthest from the dot of the ink recorded by multiple recording heads. This arrangement most effectively reduces the difference in irregularities on the surfaces of the recording media after curing of the ink, and ensures uniform glossiness and improved image quality.

According to the aforementioned (4), the center position of the ink dot recorded by the aforementioned one of the recording heads can be recorded in the position shifted from that of the ink dot recorded by other recording heads, by a simple operation. This arrangement easily reduces the difference in irregularities on the surfaces of the recording media and ensures improved image quality.

According to the aforementioned (5), the center position of the ink dot of yellow having the maximum lightness of all fundamental colors is recorded at the position shifted from that of the other ink dots. This feature reduces the apparent color registration error of the image recorded on the recording medium, and ensures a sharp image to be formed.

According to the aforementioned (6), recording is carried when the center position of the dot of the ink having the lowest recording density is shifted from that of the ink dots. This feature avoids color registration error, and ensures a sharp image to be formed. This invention is particularly effective in avoiding color registration error in the print area of high recording density such as the characters printed in black or its similar color.

According to the aforementioned (7), recording is carried out when the center position of the dot of the ink having the maximum glossiness is shifted from that of other ink dots. This arrangement provides uniform glossiness in the image recorded on the recording medium.

According to the aforementioned (8), the difference in the irregularities on the surfaces of the recording media can be reduced, and this feature ensures the improved image quality.

According to the inkjet recording apparatus described in (9), the center position of the recorded clear ink dot is freely shifted from the center position of the dot of the color ink by the aforementioned controller of the inkjet recording apparatus. This procedure avoids the mixing between the color ink and clear ink, and reduces the difference in irregularities on the surfaces of the recording media after curing of the ink. Thus, this procedure reduces the bleeding of ink, increase of dot diameter and irregularities on the surfaces of the recording media, and ensures uniform glossiness and improved image quality. The user can freely shift the superimposition of the dots of the recorded color ink and clear ink, thereby getting a degree of glossiness and hue different from those by the conventional method. Thus, this feature provides the advantage of allowing the glossiness and hue to be selected in conformity to the taste of the user.

According to the inkjet recording apparatus described in (10), the center position of the clear ink dot is recorded at a distance equivalent to half the distance from the center position of the dot of the aforementioned color ink to that of the dot of the adjacent color ink, by means of the aforementioned controller of the inkjet recording apparatus. This arrangement ensures effective prevention of the mixing between color ink and clear ink, and reduces the difference in the irregularities on the surfaces of the recording media after curing of the color ink and clear ink. This procedure reduces the bleeding of ink, increase of dot diameter and irregularities on the surfaces of the recording media, and ensures uniform glossiness and improved image quality.

According to the inkjet recording apparatus described in (11), the center position of the dot of the aforementioned clear ink is recorded in the oblique direction with respect to that of the dot of the color ink, by the controller of the inkjet recording apparatus, described in (9) and (10). This arrangement avoids the mixing between color ink and clear ink, and reduces the difference in the irregularities on the surfaces of the recording media after curing of ink, thereby minimizing the bleeding of ink, increase of dot diameter and irregularities on the surfaces of the recording media, and ensures uniform glossiness and improved image quality. It also minimizes an overflow of color ink even when the water based ink is used as color ink. Thus, this arrangement minimizes the bleeding of ink, increase of dot diameter and irregularities on the surfaces of the recording media caused by overflow of ink, and ensures uniform glossiness and improved image quality.

According to the aforementioned (12), in the inkjet recording apparatus described in any one of (9) through (11), the aforementioned clear ink recording head where the center position of the ink outlet of the clear ink recording head is located is provided in the position between the center position of the ink outlet of the color ink recording head and that of the ink outlet of the adjacent color ink recording head. This arrangement ensures most effective prevention of the mixing between color ink and clear ink, and reduces the difference in the irregularities on the surfaces of the recording media, thereby minimizing bleeding of ink, increase of dot diameter and irregularities on the surfaces of the recording media, and ensures uniform glossiness and improved image quality. It also minimizes an overflow of color ink even when the water based ink is used as color ink. Thus, this arrangement minimizes the bleeding of ink, increase of dot diameter and irregularities on the surfaces of the recording media caused by overflow of ink, and ensures uniform glossiness and improved image quality.

According to the aforementioned (13), the arrangement adopted in the inkjet recording apparatus described in any one of (9) through (12) avoids mixing between the color ink containing the coloring agents of at least cyan, magenta, yellow and black, and the clear ink, and reduces the difference in the irregularities on the surfaces of the recording media. This arrangement minimizes the bleeding of ink, increase of dot diameter and irregularities on the surfaces of the recording media, and ensures uniform glossiness and improved image quality.

The Preferred Embodiment

The following describes the preferred embodiment of the present invention with reference to drawings, without the present invention being restricted thereto.

[Embodiment 1]

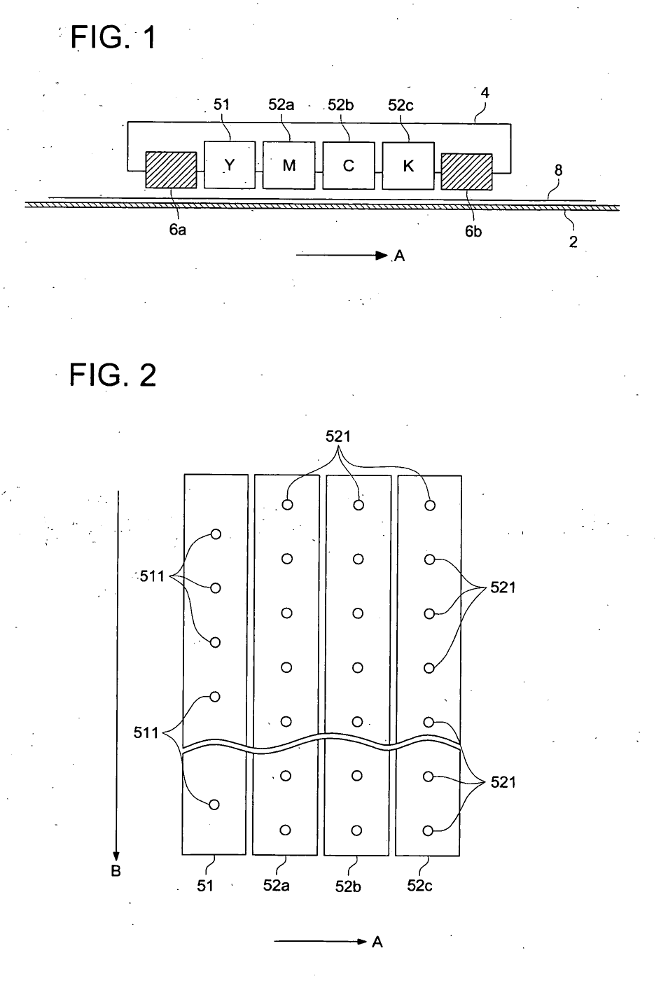

FIG. 1 is a schematic front view of the major configuration of the recording section of an inkjet recording apparatus based on serial head structure as a first embodiment, as viewed from the secondary scanning direction. The inkjet recording apparatus based on serial head structure has a flat platen 2 for supporting the non-recorded surface (reverse side of the recorded side) of a recording medium 8, and transport rollers (not illustrated) are arranged on the front and back of the platen 2. Each of the transfer rollers is designed to rotate about the axis in a predetermined direction on the front and back of the platen 2. Rotation of these transport rollers causes the recording medium 8 to be transported in the secondary scanning direction B of the image recording section.

An image recording section having a carriage for recording the image on the recorded side of the recording medium 8 and guide member are arranged above the platen 2. The image recording section has a guide member (not illustrated) extending in the primary scanning direction A, and the guide member supports the carriage 4. A recording head 51 of yellow (Y), a recording head 52a of magenta (M), a recording head 52b of cyan (C), and a recording head 52c of black (K) are arranged on the carriage 4 in the primary scanning direction A. These recording heads each has an ink outlet on the side opposite to the recording medium 8. The recording heads 51 and 52a through 52c are connected with the ink tanks for storing the ink of yellow, magenta, cyan and black (not illustrated).

Light exposure devices 6a and 6b for curing the ink hitting the recording heads are provided on both sides of a group of the aforementioned recording heads. The light used in the present embodiment includes the electromagnetic wave such as ultraviolet ray, electronic light, X-ray, visible light and infrared ray. The light source can be a fluorescent lamp, but use of an ultraviolet ray source is preferred to improve curing effects. A mercury lamp, metal halide lamp, black light, cathode tube or LED (Light-Emitting Diode) can be used. The carriage 4 with such a light source mounted thereon is guided by the guide member and can be freely moved (in reciprocation) in the primary scanning direction A.

As shown in FIG. 2, the ink outlets 521 of the recording heads 52a through 52c are arranged at an equally spaced interval in rows. By contrast, the ink outlets 511 of the recording head 51a are arranged at an equally spaced interval in rows in the secondary scanning direction B so as to be located at the intermediate position of the ink outlets 521, 521, . . . of the-recording heads 52a through 52c.

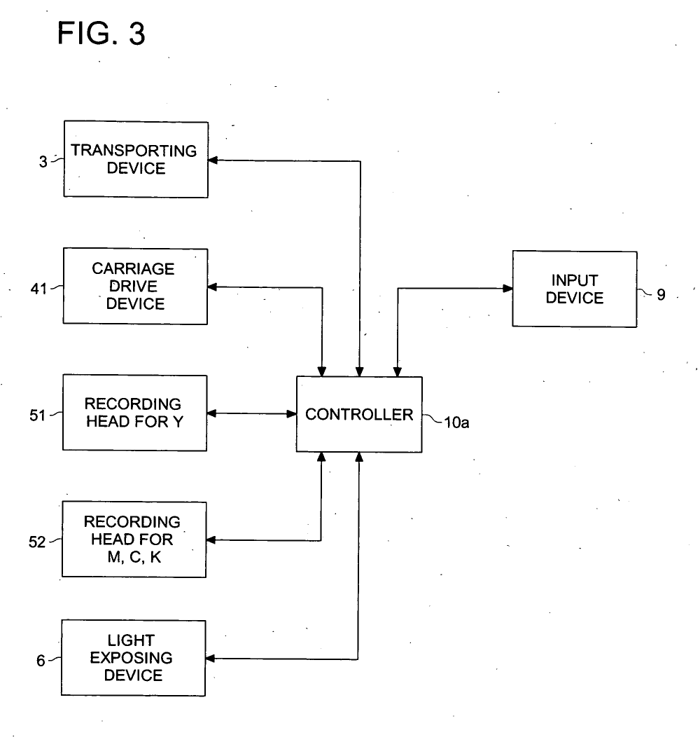

The inkjet recording apparatus is provided with a controller 10a for controlling each drive unit shown in FIG. 3.

The controller of the present embodiment is provided with an interface, such a memory device as a ROM, and CPU, and is connected with the drive sources for the transporting apparatus 3, carriage 4 and recording heads 51, 52a through 52c, as well as to the light exposure device 6 and input device 9.

The controller 10a expands the program stored in the memory circuit in advance, in a predetermined area and executes processing in conformity to the program, thereby controlling the carriage drive apparatus 41, recording heads 51, 52a through 52c, transporting apparatus 3 and light exposure device 6.

As shown in FIG. 3, the controller 10a is designed to control the carriage drive apparatus 41, the recording head 51 and 52a through 52c and others in the primary scanning direction A, based on the output image from the input device 9 and the like, to ensure that the center position of the yellow ink dot is recorded intermediate between the center position of the dot of the aforementioned ink of magenta, cyan and black, and that of the dot of the ink of magenta, cyan and black adjacent thereto, in the oblique direction.

The ink used in the present embodiment can be water based ink, oil based ink, photocurable ink or others. Photocurable ink suitable for use in a wide range of recording media is preferred in particular. The photocurable ink that can be used includes the ink containing radical polymerized compound, ink containing cation polymerized compound or hybrid ink consisting of their mixture. Further, to encourage effective curing reaction, it is possible to add a photo-initiator and others.

The recording medium 8 used in the present embodiment includes the plain paper, bond paper or fabric as an absorbable recording medium, and a plastic, resin film, metal and glass as a non-absorbable recording medium.

The following describes the operation of the inkjet recording apparatus according to the present invention:

At the time of image recording, the recording medium 8 is transported onto the platen 2 by the transporting apparatus 3 under the control of the controller 10a. The transport of this recording medium 8 causes a reciprocating motion of the carriage 4 in the primary scanning direction A, and ink is ejected from the ink outlets 511 and 521.

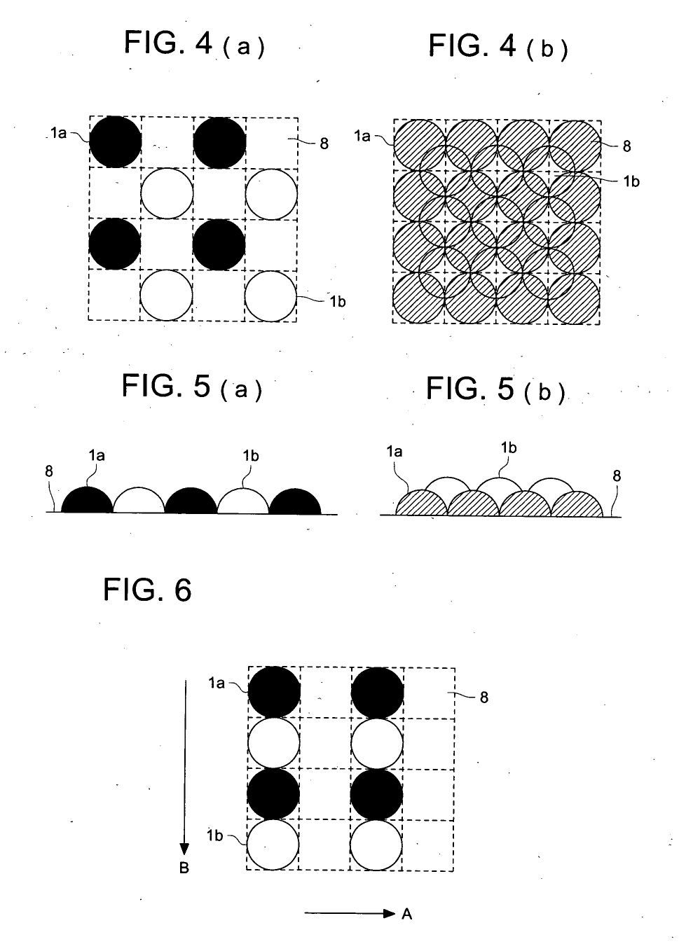

FIGS. 4(a) and 4(b) are schematic top views as an enlarged view showing part of the recording medium 8 which the ink of magenta, cyan and black and the yellow ink have hit. As shown in FIGS. 4(a) and 4(b), the dot 1a of the ink of magenta, cyan and black is recorded by the ink outlet 521. At the same time, the aforementioned yellow ink dot 1b is recorded by the ink outlet 511, intermediate between the center position of the dot la of the ink of magenta, cyan and black, and that of the dot la adjacent thereto, in the oblique direction. The magenta, cyan and black ink, and the yellow ink are exposed to light by the reciprocating motion of the carriage 4 equipped with light exposure devices 6a and 6b under the control of the controller 10a, whereby photocuring is performed. This procedure allows the image to be recorded on the recording medium 8.

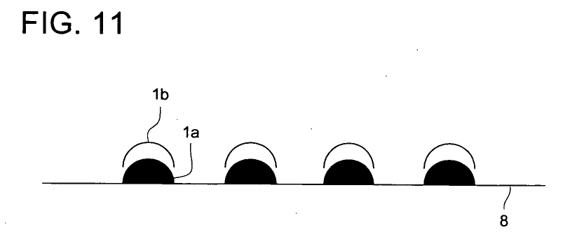

As described above, recording is performed when the center position of the dot of the aforementioned ink of magenta, cyan and black is shifted from the center position of the yellow ink dot, in the secondary scanning direction B. As will be apparent from the cross sectional view of the ink recorded on the recording medium in FIGS. 5(a) and 5(b), the ink-covered protrusion on the recording medium is reduced, as compared with the case of FIG. 11, and irregularities or gritty feel is also reduced, with the result that a clearly visible image with uniform glossiness is produced.

The controller 10a is not necessarily required to provide control in such a way that the center position of the yellow ink dot is recorded intermediate between the center position of the dot of the aforementioned ink of magenta, cyan and black, and that of the dot adjacent thereto, in the oblique direction.

As shown in FIG. 6, the same advantage can be obtained by providing control in such a way that the center position of the aforementioned yellow ink dot 1b is recorded intermediate between the dot la of the ink of magenta, cyan and black, and that of the dot la adjacent thereto, in the secondary scanning direction.

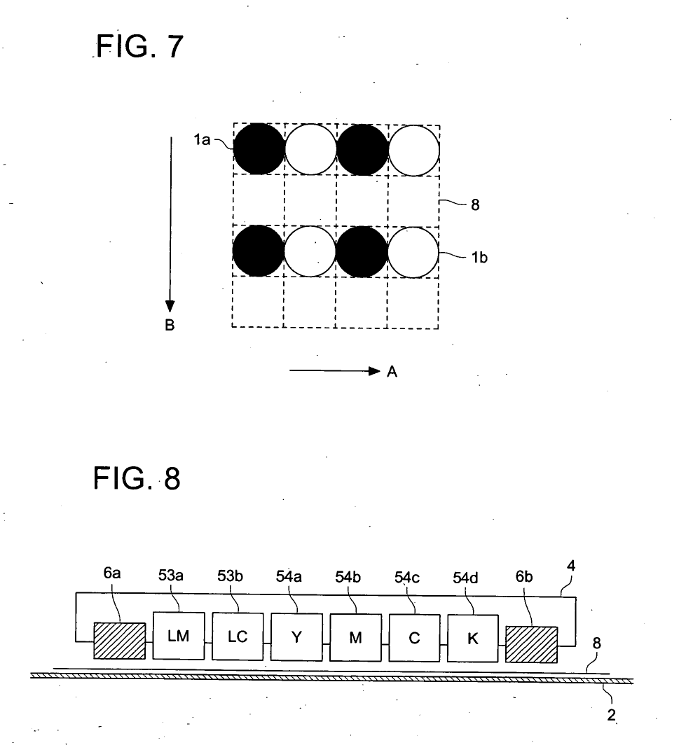

Further, as shown in FIG. 7, the same advantage can also be obtained by providing control in such a way that the center position of the yellow ink dot 1b is recorded at the position intermediate between the center position of the dot la of the aforementioned ink of magenta, cyan and black, and that of the dot la adjacent thereto, in the primary scanning direction A.

The color of the ink ejected from the aforementioned one of the recording heads can be any color of the ink to be ejected by the aforementioned multiple recording heads. When the multiple recording heads contains a plurality of fundamental colors, the fundamental color of them having the maximum lightness is ejected from the aforementioned one recording head, whereby the color registration error of the image recorded on the recording medium can be further minimized.

When water based ink or oil based ink is used instead of the photocurable ink, this arrangement provides uniform glossiness and minimizes an overflow of ink in the dot, and hence minimizes the bleeding of ink or increase of dot diameter due to overflow of ink, and ensures improved image quality.

[Embodiment 2]

The following describes the second embodiment of the inkjet recording apparatus according to the present invention, with reference to FIG. 8.

FIG. 8 is a schematic front view representing the major configuration of the recording section of an inkjet recording apparatus based on serial head structure, as viewed from the secondary scanning direction. The second embodiment is different from the first one only in the image recording section (see FIG. 1), and is the same other than that. To avoid duplication, the following mainly describes the image recording section, and the description of the same configuration as that of the first embodiment will be omitted.

The recording head 53a of light magenta (LM), recording head 53b of light cyan (LC), recording head 54a of yellow, recording head 54b of magenta, recording head 54c of cyan, and recording head 54d of black are mounted on the carriage 4 in the primary scanning direction A. These recording heads have ink outlets on the side opposite to the recording medium 8. Recording heads 53a, 53b, and 54a through 54d are connected to the ink tanks (not illustrated) for storing the ink of light magenta, light cyan, yellow, magenta, cyan and black. Light exposure devices 6a and 6b for curing the ink having hit the recording medium are arranged on both sides of these recording heads.

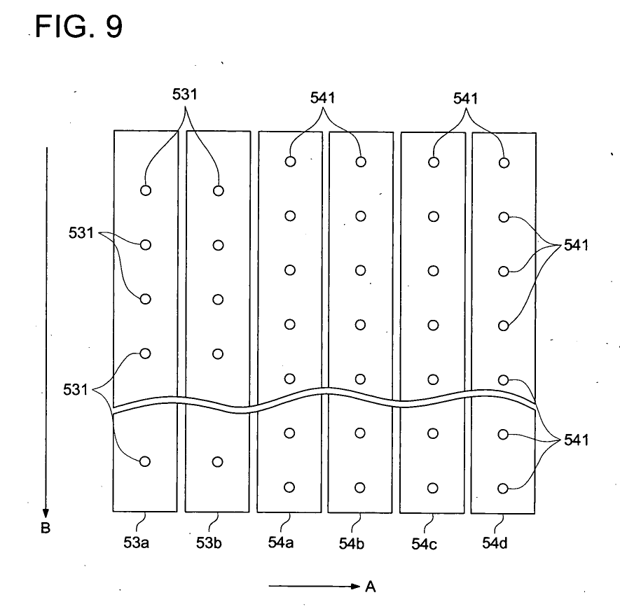

As shown in FIG. 9, the ink outlets 541 of the recording heads 54a through 54d are arranged at an equally spaced interval in rows. By contrast, the ink outlets 531. of the recording heads 53a and 53b are arranged at an equally spaced interval in rows in the secondary scanning direction B so as to be located at the intermediate position of the ink outlets 541, 541, . . . of the recording heads 54a through 54d.

Light exposure devices 6a and 6b equipped with a light exposure source for applying light to the ink having reached the recording medium 8 are arranged on both sides of the recording heads on both ends mounted on the carriage 4.

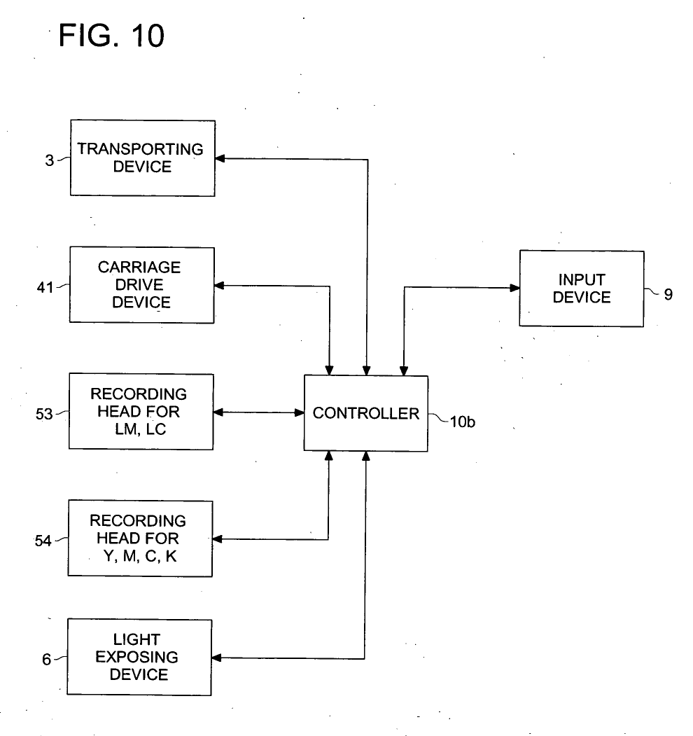

The inkjet recording apparatus is equipped with a controller 10b to control each drive section as shown in FIG. 10. The controller 10b is configured to control the carriage drive device 41 and the recording heads 53a, 53b and 54a through 54d in the primary scanning direction A, in such a way that the center position of the light magenta and light cyan ink dots is recorded intermediate between the center position of the dot of the aforementioned ink of yellow, magenta, cyan and black and that of the dot of the ink of yellow, magenta, cyan and black adjacent in the oblique direction, based on the output from the input device 9 or the like.

Ink of various types is ejected based on the aforementioned configuration, whereby, similarly to the case of the first embodiment, the center position of the light magenta and light cyan ink dots is recorded intermediate between the center position of the dot of the aforementioned ink of yellow, magenta, cyan and black and that of the dot of the ink of yellow, magenta, cyan and black adjacent in the oblique direction.

The carriage 4 equipped with light exposure devices 6a and 6b makes a reciprocating motion under the control of the controller 10b, and light is applied to these types of ink (U), whereby ink is photocured. This procedure allows the image to be recorded on the recording medium 8.

As described above, when a plurality of recording heads for ejecting the ink of the same hue are contained, recording is performed when the center position of the dot of the ink of the same hue, having the lowest recording density, is shifted from the center position of the dot of the ink having the highest recording density. This arrangement provides the advantage of avoiding apparent color registration error on the image recorded on the recording medium, in addition to the same advantages as those of the first embodiment.

In the second embodiment, the same advantages as the above can be obtained by providing control in such a way that the center position of the light magenta and light cyan ink dots is recorded intermediate between the center position of the dot of the aforementioned ink of yellow, magenta, cyan and black, and that of the dot of the ink of yellow, magenta, cyan and black adjacent thereto, in the secondary scanning direction B or primary scanning direction A.

As is clear from the second embodiment, where there are multiple combinations of the ink of the same hue, such as light magenta and light cyan, recording is performed by shifting the center position of the dot of the ink having the lowest recording density in all these combinations, from the center position of the dot of the ink having the high recording density.

In the aforementioned configuration, recording may be performed by shifting the center position of the dot of the ink having the greatest glossiness, from the center position of the dot of other ink. This arrangement provides uniform glossiness in the image recorded on the recording medium.

In the aforementioned description, reference has been made only to the inkjet recording apparatus based on serial head structure. Without being restricted thereto, the present invention produces the same advantages in an inkjet recording apparatus based on the line head structure by providing the same control in the inkjet recording apparatus based on the line head structure. It should be added that “oblique direction” in the case of the line head structure refers to the direction of the row of ink outlets of each recording head and the recording medium transport direction orthogonal thereto.

[Embodiment 3]

The following describes the third embodiment of the inkjet recording apparatus according to the present invention, with reference to drawings, without the present invention being restricted thereto.

The inkjet printer recording apparatus of FIG. 12 is an inkjet printer recording apparatus based on the serial head structure. This inkjet printer recording apparatus is equipped with a flat platen 102, which supports the recording medium 8 from the non-recorded surface. It supports the recorded surface of the recording medium 8 in an approximately horizontal state.

Opposite to the recorded side of the recording medium 8 of the platen 102, there is a guide rail (not illustrated) extending across the entire width of the recording medium 8 supported by the platen 102, in the direction orthogonal to the secondary scanning direction B. This guide rail supports the carriage 104.

The carriage 104 is equipped with a plurality of recording heads based on inkjet recording method having ink ejection surface with an ink outlet formed on the side opposite to the recording medium 8. The clear ink recording head 151 for ejecting the clear ink (C1) and four color ink recording heads 152, 152, . . . for ejecting the color ink are arranged in the primary scanning direction. The color ink recording heads 152, 152, . . . each are connected with the ink tanks for storing the ink of black (K), cyan (C), magenta (M) and yellow (Y). The clear ink recording head 151 is connected with the ink tank for storing the clear ink (C1) (not illustrated).

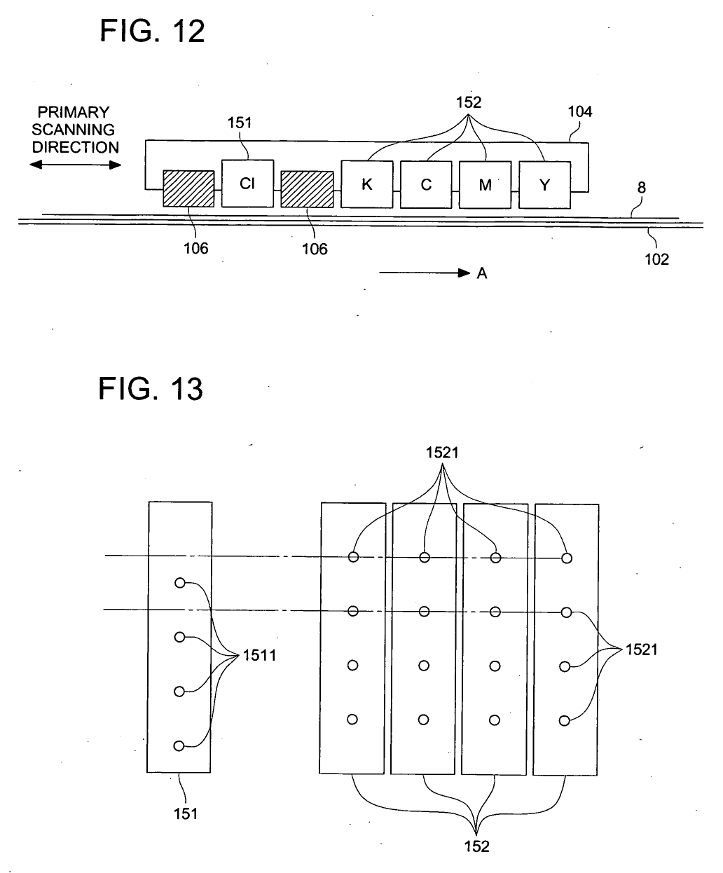

As shown in FIG. 13, a plurality of nozzles 1521 of each of the color ink recording heads are arranged at an equally spaced interval in rows. The nozzles 1511 of the clear ink recording head are arranged at an equally spaced interval in rows at the position half the distance between the nozzles 1521, 1521, . . . of the color ink recording heads.

Light exposure devices 106 and 106 equipped with a light exposure source for applying light to the clear ink and color ink having reached the recording medium 8 are arranged on both sides of the clear ink recording heads on the carriage 104.

The light used in the present embodiment includes the electromagnetic wave such as ultraviolet ray, electronic light, X-ray, visible light and infrared ray. The light source can be a fluorescent lamp, but use of an ultraviolet ray source is preferred to improve curing effects. A mercury lamp, metal halide lamp, black light, cathode tube or LED (Light-Emitting Diode) can be used.

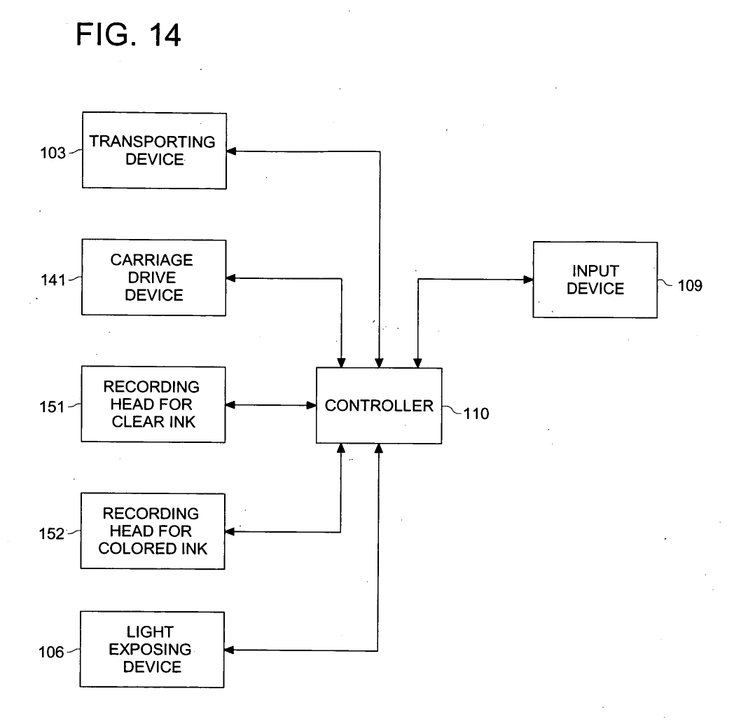

The inkjet recording apparatus is provided with the controller 110 for controlling each drive section, as shown in FIG. 14.

The controller 110 is composed of an interface, such a memory device as a ROM, and CPU, and is connected with the drive sources for the transporting device 103, carriage 104 and clear ink recording head 151 and color ink recording head 152, as well as to the light exposure device 106 and input device 109.

The controller 110 a expands the program stored in the memory circuit in advance, in a predetermined area and executes processing in conformity to the program, thereby controlling the drive sources for the carriage 104 and clear ink recording head 151 and color ink recording head 152, as well as the transporting apparatus 103 and light exposure device 106.

As shown in FIG. 16(a) and 16(b), the controller 110 is designed to control the carriage drive apparatus 141, the clear ink recording head 151 and color ink recording heads 152, 152, . . . in the primary scanning direction A, to ensure that the center position of the clear ink dot is recorded intermediate between the center position of the dot of the aforementioned color ink based on the output image from the input device 109, and that of the dot of the color ink adjacent in the oblique direction.

The ink used in the present embodiment can be water based ink, oil based ink, photocurable ink or others. Photocurable ink suitable for use in a wide range of recording media is preferred in particular. The photocurable ink that can be used includes the ink containing radical polymerized compound, ink containing cation polymerized compound or hybrid ink consisting of their mixture. Further, to encourage effective curing reaction, it is possible to add a photo-initiator and others.

The recording medium 8 used in the present embodiment includes the plain paper, bond paper or fabric as an absorbable recording medium, and a plastic, resin film, metal and glass as a non-absorbable recording medium.

The following describes the operation of the inkjet recording apparatus according to the present invention:

At the time of image recording, the recording medium 8 is transported onto the platen 102 by the transporting apparatus 103 under the control of the controller 110. The transport of this recording medium 8 causes a reciprocating motion of the carriage 104 in the primary scanning direction A, and the color ink dot is recorded from the nozzles 1511, 1521, 1521, . . . shown in FIG. 13. At the same time, the center position of the clear ink dot is recorded at the position half the distance between the center position of the dot of the aforementioned color ink and that of the dot of the color ink adjacent thereto, in the oblique direction. The carriage 104 equipped with light exposure devices 106 and 106 makes a reciprocating motion under the control of the controller 110, and light is applied to the color ink and clear ink recorded on the recording medium 8, whereby ink is photocured. This procedure allows the image to be recorded on the recording medium 8.

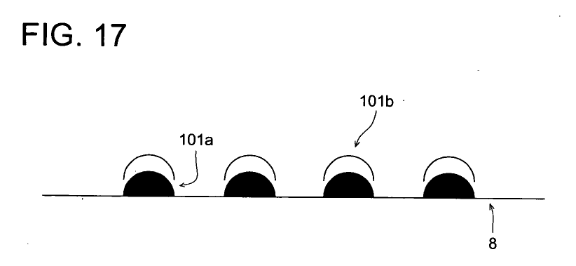

As described above, according to the inkjet recording apparatus of the present embodiment, the center position of the clear ink dot is set at the position half the distance from the center position of the dot of the aforementioned color ink and that of the dot of the color ink adjacent thereto, under the control of the controller 110, in the direction perpendicular to the transport direction. As shown in FIG. 13, the position of the clear ink nozzle 1511 is shifted from the position of the color ink nozzles 1521, 1521 . . . by ½ in the transport direction, whereby the center positions of the color ink dot 101a and clear ink dot 101b are recorded, as shown in FIGS. 16(a) and 16(b). This procedure avoids mixing between the conventional color ink and clear ink shown in FIG. 17, reduces the difference in irregularities on the surfaces of the recording media, and hence ensures formation of an image characterized by uniform glossiness.

The controller 110 is not necessarily required to provide control in such a way that the center position of the clear ink dot is recorded at the position half the distance between the center position of the color ink dot, and that of the color ink dot adjacent thereto, in the oblique direction.

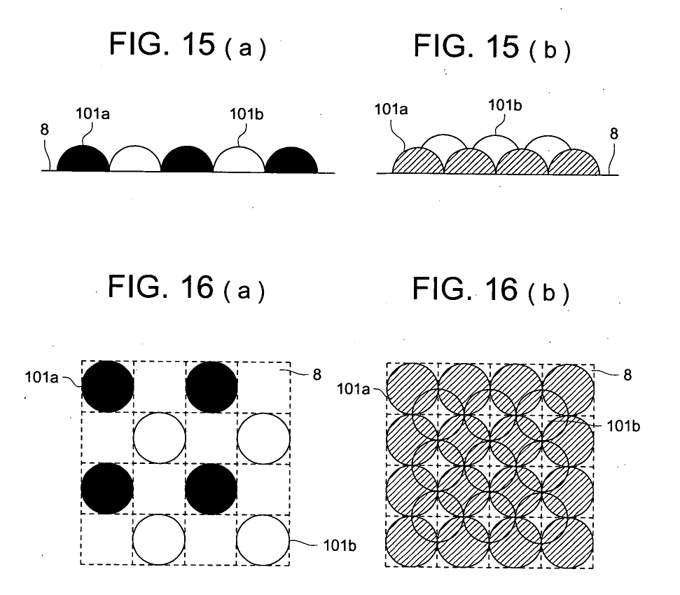

The operation in such a case, the center position of the clear ink dot 101b is recorded at the position half the distance between the center position of the color ink dot 101a, and that of the color ink dot adjacent thereto, in the transport direction, as shown in FIGS. 15(a) and 15(b).

As described above, the center position of the clear ink dot can be recorded at the position half the distance between the center position of the color ink dot, and that of the color ink dot adjacent thereto. This arrangement avoids mixing between the color ink and clear ink, and reduces the difference in irregularities on the surfaces of the recording media, with the result that an image conforming to the taste of a user can be formed.

The center position of the clear ink nozzle need not necessarily be shifted so as to be located at the position half the distance between the center position of the color ink nozzle, and that of the adjacent color ink nozzle.

The operation in such a case, the center position of the clear ink dot is recorded at the position half the distance between the center position of the dot of the aforementioned color ink and that of the dot of the color ink adjacent thereto, in the direction perpendicular to the transport direction, as shown in FIGS. 15(a) and 15(b).

As described above in the center position of the clear ink dot can be recorded at the position half the distance between the center position of the dot of the aforementioned color ink and that of the dot of the color ink adjacent thereto, in the direction perpendicular to the transport direction. This arrangement avoids mixing between the color ink and clear ink, and reduces the difference in irregularities on the surfaces of the recording media, with the result that an image conforming to the taste of a user can be formed.

The controller 110 need not necessarily provide control in such a way that the center position of the dot of the clear ink is recorded at the position half the distance between the center position of the dot of the color ink and that of the dot of the adjacent color ink in the oblique direction, to ensure that the user can freely adjust settings from the input device 109 to shift the center positions of the color ink dot and clear ink dot in the primary or secondary scanning direction. Further, it is not necessarily required to shift the center position of the clear ink nozzle so that it is located half the distance between the center position of the color ink nozzle and that of the adjacent color ink nozzle.

The operation in this case is performed in such a way that the center position of the clear ink dot is recorded at the center position set by the user freely operating the input device 109 to shift the center positions of the color ink dot and clear ink dot in the direction perpendicular to the transport direction or in the transport direction.

As described above, this arrangement allows the user to freely record the center position of the clear ink dot, and to form an image conforming to his or her taste.

1. An inkjet recording apparatus comprising:
a plurality of recording heads, each of the plurality of recording heads being provided with an outlet for ejecting photocurable ink of different color from each other;
a light exposure device for curing the photocurable ink ejected;
a controller for controlling ejection of the photocurable ink in such a way that a center position of an ink dot recorded by one of the plurality recording heads is positioned at a position shifted from a center position of an ink dot recorded by other multiple heads of the plurality of recording heads.

2. The inkjet recording apparatus of claim 1, wherein the controller controls ejection from said one of the plurality of recording heads in such a way that the center position of the ink dot recorded by said one of the plurality of recording heads is positioned intermediately between a center position of a first ink dot and a center position of a second ink dot adjacent to the first ink dot, the first ink dot and the second ink dot being recorded by said other multiple heads of the plurality of recording heads.

3. The inkjet recording apparatus of claim 1, wherein the controller controls ejection from said one of the plurality of recording heads in such a way that the center position of the ink dot recorded by said one of the plurality of recording heads is positioned intermediately between a center position of the first ink dot and a center position of a second ink dot adjacent to the first ink dot in an oblique direction, the first ink dot and the second ink dot being recorded by said other multiple heads of the plurality of recording heads.

4. The inkjet recording apparatus of claim 1, wherein a center position of the ink outlet of said one of the plurality recording heads is provided between a center position of a first ink outlet and a center position of a second ink outlet adjacent to the first ink outlet, both of the first ink outlet and the second ink outlet being provided on said other multiple heads of the plurality of recording heads.

5. The inkjet recording apparatus of claim 1, wherein said one of the plurality of recording heads is a recording head for ejecting photocurable ink of yellow color.

6. The inkjet recording apparatus of claim 1, wherein the plurality of recording heads comprises multiple recording heads for ejecting ink of a same kind of hue, wherein the recording head for ejecting ink of the lowest recording density among the multiple recording heads is said one of the plurality of recording heads.

7. The inkjet recording apparatus of claim 1, wherein said one of the plurality of recording heads is a recording head for ejecting photocurable ink of fundamental color having the maximum glossiness after recording.

8. The inkjet recording apparatus of claim 1, wherein the plurality of recording heads comprises the recording heads for respectively ejecting yellow ink, magenta ink, cyan ink and black ink.

9. An inkjet recording apparatus comprising:
a plurality of recording heads, each of the plurality of recording heads being provided with an outlet for ejecting photocurable ink, the plurality of recording heads comprising a recording head for ejecting color ink and a recording head for ejecting clear ink;
a light exposure device for curing the photocurable ink ejected;
a transporting section for transporting a recording medium; and
a controller for controlling ejection of the recording head for ejecting clear ink, in such a way that a center position of a clear ink dot recorded by the recording head for ejecting clear-ink is positioned at a position shifted from a center position of an color ink dot recorded by the recording head for ejecting color ink.

10. The inkjet recording apparatus of claim 9, wherein the controller controls in such a way that the center position of the clear ink dot is positioned substantially at a middle point between a center position of a first color ink dot and a center position of a second color ink dot adjacent to the first color ink dot.

11. The inkjet recording apparatus of claim 9, wherein the controller controls in such a way that the center position of the clear ink dot is shifted from the center position of a color ink dot in a direction between a transporting direction of the recording media and a direction perpendicular to the transporting direction.

12. The inkjet recording apparatus of claim 9, wherein a center position of the ink outlet of recording head for ejecting clear ink is provided between a center position of a first ink outlet and a center position of a second ink outlet adjacent to the first ink outlet, both of the first ink outlet and the second ink outlet being provided on the recording head for ejecting color ink.

13. The inkjet recording apparatus of claim 9, wherein the color ink comprises inks respectively including cyan, magenta, yellow and black color agent.
